(19) United States
(12) Patent Application Publication
(10) Pub. No.: US 2025/0295129 A1
(43) Pub. Date: Sep. 25, 2025

(54) PARTICULATE COMPOSITION COMPRISING DIACETATE COMPONENT, DISODIUM DIPHOSPHATE AND ANOTHER ORGANIC ACID SALT

(71) Applicant: PURAC Biochem B.V., Gorinchem (NL)

(72) Inventors: Anh Linh NGUYEN, Gorinchem (NL); Prita PRITAWARDANI, Gorinchem (NL); Francis Ben FABELA, Gorinchem (NL)

(73) Assignee: PURAC Biochem B.V., Gorinchem (NL)

(21) Appl. No.: 19/232,085

(22) Filed: Jun. 9, 2025

Related U.S. Application Data
(63) Continuation of application No. PCT/EP2023/084058, filed on Dec. 4, 2023.

(30) Foreign Application Priority Data
Dec. 9, 2022 (EP) 22212606.2

(51) Int. Cl. A23B 2/754; A23B 2/788; A23B 4/20; A23B 4/24

(52) U.S. Cl. CPC A23B 2/754; A23B 2/788; A23B 4/20; A23B 4/24

(57) ABSTRACT

A particulate composition is disclosed, comprising, calculated by weight of dry matter: (a) 25-85 wt. % of organic acid salt selected from sodium acetate, potassium acetate, sodium lactate, potassium lactate, calcium lactate, sodium propionate, potassium propionate and combinations thereof; (b) 6-40 wt. % of diacetate component selected from sodium diacetate, potassium diacetate and combinations thereof; and (c) 5-30 wt. % of disodium diphosphate; wherein components (a), (b), and (c) together constitute at least 80 wt. % of the dry matter that is contained in the particulate composition. The particulate composition may suitably be applied as a food preservative, e.g. in meat products.

### RELATED APPLICATIONS

The present application is a continuation application of PCT/EP2023/084058 filed Dec. 4, 2023, which claims priority to EP 22212606.2 filed Dec. 9, 2022, the entire contents of both which are incorporated herein by reference.

### TECHNICAL FIELD OF THE INVENTION

The present invention relates to a particulate composition comprising:
organic acid salt selected from sodium acetate, potassium acetate, sodium lactate, potassium lactate, calcium lactate, sodium propionate, potassium propionate and combinations thereof;
diacetate component selected from sodium diacetate, potassium diacetate and combinations thereof; and
disodium diphosphate.

The particulate composition of the present invention may suitably be applied as a food preservative, e.g. in meat products.

### BACKGROUND OF THE INVENTION

Meat preservation represents a serious challenge as contaminated meat carries the possibility of such health threats as Listeria, Salmonella and E. coli. These well-known pathogenic bacteria, which can proliferate in unprotected meats, can lead to a range of deadly medical conditions.

In addition to ensuring safe consumption for individual consumers, meat preservation and protection is an important component of a global food supply chain that is faced with the challenge of feeding a global population set to rise from seven billion currently to nine billion by the late 2030 s. For perspective, over one-third of all food produced today ends up in either the “loss” or “waste” category, costing the global economy an estimated $940 billion annually and contributing 8-10% of worldwide greenhouse gas emissions. Since meat represents the highest category of economic and environmental impact of wasted food globally, the preservation and protection of meat is a society-wide concern.

Organic acids provide a very valuable antimicrobial function that is extensively used by meat processors. These organic acids are commonly applied in the form of sodium, potassium or calcium salts. Examples of such organic acid salts include sodium acetate, potassium acetate, sodium lactate, potassium lactate, calcium lactate and sodium diacetate.

US 2013/0171314 describes an antimicrobial preservative composition for food products comprising:
18.5 to 26.0 wt. % potassium lactate;
18.5 to 26.0 wt. % potassium acetate; and
10.0 to 17.0 wt. % sodium diacetate.

US 2005/0058751 describes a process for treating meat comprising treating the meat with a first solution having a pH above 6.0 and subsequently treating the meat with a second solution having a pH of less than 5.6. Paragraphs [0038]-[0039] describe a lower pH acidic solution comprising sodium acid pyrophosphate (SAPP) and diacetate:

US 2003/0091706 relates to a method of treating meat products to inhibit growth and germination of Clostridium perfringens. In paragraphs [0041]-[0046} a preservative composition (IONAL plus) is described having the following composition
Sodium citrate 75-85 wt. %
Sodium diacetate 5-15 wt. %
Citric acid 5-15 wt. %
Sodium acid pyrophosphate 1-2 wt. %

CN104970084 relates to a meat preservative comprising:
6-11 parts by weight of calcium propionate,
5-9 parts by weight of lactic acid,
3.2-7 parts by weight of sodium lactate,
9-15 parts by weight of natural antiseptic bacteriostatic agent,
2-4 parts by weight of sodium diacetate,
8-12 parts by weight of sucrose ester,
6-8 parts by weight of sorbic acid,
10-13 parts by weight of natural spirit extract,
2-5 parts by weight of sodium pyrophosphate,
7-9 parts by weight of glyceryl monostearate,
0.5-2 parts by weight of starch,
0.2-0.6 parts by weight of lysozyme.

BE 1 020 863 describes a food preservative composition that increases the shelf life of meat, fish or seafood products, the composition having bactericidal activity and comprising a water-soluble mixture of lactate and acetate or alkaline diacetate.

BE 1 020 864 describes a composition having antimicrobial, water-retentive and texturizing activity, and that increases the shelf life of finely emulsified and cooked meat or fish products, the composition comprising a mixture in the form of powder of lactate, acetate and vegetable fibers and/or starch.

### SUMMARY OF THE INVENTION

The inventors have unexpectedly discovered that a preservative composition with excellent properties is obtained when the following acid salts are combined in a carefully balanced mixture:
(i) organic acid salt selected from sodium acetate, potassium acetate, sodium lactate, potassium lactate, calcium lactate, sodium propionate, potassium propionate and combinations thereof;
(ii) diacetate component selected from sodium diacetate, potassium diacetate and combinations thereof; and
(iii) disodium diphosphate.

The particulate composition according to the invention comprises, calculated by weight of dry matter:
a) 25-85 wt. % of organic acid salt selected from sodium acetate, potassium acetate, sodium lactate, potassium lactate, calcium lactate, sodium propionate, potassium propionate and combinations thereof;
b) 6-40 wt. % of diacetate component selected from sodium diacetate, potassium diacetate and combinations thereof;
c) 5-30 wt. % of disodium diphosphate;
wherein components a), b), and c) together constitute at least 80 wt. % of the dry matter that is contained in the particulate composition.

Although the inventors do not wish to be bound by theory, it is believed that the combined action of the diacetate component and the disodium diphosphate boosts the overall preservative action of the particulate composition. Furthermore, the particulate composition of the present invention has a favourable impact on important sensory attributes of meat products.

Another aspect of the invention relates to a method of preserving a food product, said method comprising (i) mixing one or more food ingredients with the particulate composition of the present invention and/or (ii) applying the particulate composition of the present invention onto the surface of a food product.

The invention also provides a process of preparing the particulate composition of the present invention, the process comprising mixing together the following powders:
a first powder containing at least 50 wt. % of organic acid salt selected from sodium acetate, potassium acetate, sodium lactate, potassium lactate, calcium lactate, sodium propionate, potassium propionate and combinations thereof;
a second powder containing at least 50 wt. % of diacetate component selected from sodium diacetate, potassium diacetate and combinations thereof;
a third powder containing at least 50 wt. of disodium diphosphate.

### DETAILED DESCRIPTION OF THE INVENTION

A first aspect of the invention relates to a particulate composition comprising, calculated by weight of dry matter:
a) 25-85 wt. % of organic acid salt selected from sodium acetate, potassium acetate, sodium lactate, potassium lactate, calcium lactate, sodium propionate, potassium propionate and combinations thereof;
b) 6-40 wt. % of diacetate component selected from sodium diacetate, potassium diacetate and combinations thereof;
c) 5-30 wt. % of disodium diphosphate;
wherein components a), b), and c) together constitute at least 80 wt. % of the dry matter that is contained in the particulate composition.

Concentrations expressed by weight of dry matter as mentioned herein refer to the amount of dry ingredient that is present in a composition as a percentage of the total amount of dry matter that is contained in the same composition.

Whenever reference is made to a salt, unless indicated otherwise, both anhydrous and hydrated forms of the salt are encompassed.

The term “disodium diphosphate” as used herein is synonymous with sodium acid pyrophosphate (SAPP).

Together, the components a), b), and c) preferably constitute at least 85 wt. %, more preferably at least 90 wt. % and most preferably at least 92 wt. % of the dry matter that is contained in the particulate composition.

Besides components a), b), and c), the particulate composition may suitably contain other components, such as anticaking agents, bacteriocins and acids.

Preferably, the particulate composition comprises, calculated by weight of dry matter, 40-82 wt. %, more preferably 50-81 wt. % and most preferably 60-80 wt. % of organic acid salt selected from sodium acetate, potassium acetate, sodium lactate, potassium lactate, calcium lactate, sodium propionate, potassium propionate and combinations thereof. More preferably, the organic acid salt that is employed in the aforementioned concentration is selected from sodium acetate, potassium acetate, sodium lactate, potassium lactate and combinations thereof.

The diacetate component selected from sodium diacetate, potassium diacetate and combinations thereof is preferably contained in the particulate composition in a concentration, calculated by weight of dry matter of 8-35 wt. %, more preferably of 10-25 wt. %. More preferably, the diacetate that is employed in the aforementioned concentration is sodium diacetate.

Disodium diphosphate is preferably contained in the particulate composition in a concentration, calculated by weight of dry matter, of 6-25 wt. %, more preferably of 7-20 wt. %.

According to one preferred embodiment, the particulate composition comprises, calculated by weight of dry matter, 25-85 wt. % of organic acid salt selected from sodium acetate, potassium acetate and combinations thereof. Even more preferably, the particulate composition comprises, calculated by weight of dry matter 50-85 wt. % of organic acid salt selected from sodium acetate, potassium acetate and combinations thereof. Yet more preferably, the particulate composition comprises, calculated by weight of dry matter 50-85 wt. % of sodium acetate. In a particularly preferred embodiment, the particulate composition comprises, calculated by weight of dry matter:
a) 55-80 wt. % of sodium acetate;
b) 7-30 wt. % of sodium diacetate;
c) 5-25 wt. % of disodium diphosphate.

In another preferred embodiment, the particulate composition comprises, calculated by weight of dry matter 20-60 wt. % of acetate selected from sodium acetate, potassium acetate and combinations thereof; and 15-55 wt. % of lactate selected from sodium lactate, potassium lactate and combinations thereof. More preferably, the particulate composition comprises, calculated by weight of dry matter 20-60 wt. % of sodium acetate and 15-55 wt. % of sodium lactate. In a particularly preferred embodiment this particulate composition comprises, calculated by weight of dry matter:
a) 25-50 wt. % of sodium acetate;
b) 25-50 wt. % of sodium lactate;
c) 10-40 wt. % of sodium diacetate;
d) 5-25 wt. % of disodium diphosphate.

The particulate composition according to the present invention may suitably be prepared in the form of a powder blend. Preferably, the particulate composition is a blend of at least three powders, including:
a first powder containing at least 50 wt. %, more preferably at least 80 wt. % of organic acid salt selected from sodium acetate, potassium acetate, sodium lactate, potassium lactate, calcium lactate, sodium propionate, potassium propionate and combinations thereof;
a second powder containing at least 50 wt. %, more preferably at least 80 wt. % of diacetate component selected from sodium diacetate, potassium diacetate and combinations thereof;
a third powder containing at least 50 wt., more preferably at least 80 wt. % of disodium diphosphate.

Preferably, the first powder contains at least 50 wt. %, more preferably at least 80 wt. % of organic acid salt selected from sodium acetate, potassium acetate, sodium lactate, potassium lactate and combinations thereof. Even more preferably, the first powder contains at least 50 wt. %, more preferably at least 80 wt. % of organic acid salt selected from sodium acetate, potassium acetate and combinations thereof. Most preferably, the first powder contains at least 50 wt. %, more preferably at least 80 wt. % of sodium acetate.

Preferably, the second powder contains at least 50 wt. %, more preferably at least 80 wt. % of sodium diacetate.

The particulate composition of the present invention preferably has a volume weighted average diameter (D [4,3]) in the range of 100 to 500 micrometer, more preferably in the range of 140 to 350 micrometer.

Preferably at least 90 vol. % of the particles in the particulate composition have a diameter D (v,0.9) of less than 800 micrometer, more preferably of less than 600 micrometer.

Preferably not more than 10 vol. % of the particles in the particulate composition have a diameter (Dv,0.1) of less than 20 micrometer, more preferably of less than 30 micrometer.

The span of the particulate composition [(Dv,0.9-Dv,0.1)/Dv,0.5] is preferably less than 3.0, more the span of the particular composition is in the rang of 1.8 to 2.5.

The particle size distribution of the particulate composition may suitably be determined by laser diffraction, using a Malvern particle size analyzer.

The water content of the particulate composition preferably does not exceed 15 wt. %, more preferably it does not exceed 12 wt. %. Here the water content includes free water as well as hydrate water.

The particular composition of the present invention typically acts as a mild acidulent. Accordingly, in a preferred embodiment, dissolution of 1 gram of the particulate composition in 1 litre of distilled water of 20° C. yields a solution having a pH in the range of 5.0 to 6.3, preferably in the range of 5.2 to 6.0, most preferably in the range of 5.4 to 5.9.

Another aspect of the invention relates to a method of preserving a food product, said method comprising (i) mixing one or more food ingredients with a particulate composition according to any one of the preceding claims and/or (ii) applying the particulate composition according to any one of the preceding claims onto the surface of a food product.

Preferably, the present method of preserving a food product comprises mixing 1000 parts by weight of the one or more other ingredients with 1 to 20 parts by weight, more preferably 3 to 10 parts by weight, most preferably 4 to 8 parts by weight of the particulate composition.

The present method may be used to preserve a variety of food products, such as meat products, seafood products, bakery products, chilled prepared food, sauces, dressings and water based fillings. According to a particularly preferred embodiment, the food product that is preserved by the present method is a meat product.

Yet another aspect of the invention relates to a process of preparing a particulate composition according to the present invention, the process comprising mixing together the following powders:
a first powder containing at least 50 wt. %, preferably at least 80 wt. % of organic acid salt selected from sodium acetate, potassium acetate, sodium lactate, potassium lactate, calcium lactate, sodium propionate, potassium propionate and combinations thereof;
a second powder containing at least 50 wt. %, preferably at least 80 wt. % of diacetate component selected from sodium diacetate, potassium diacetate and combinations thereof;
a third powder containing at least 50 wt. %, preferably at least 80 wt. % of disodium diphosphate.

Preferably, the first powder contains at least 50 wt. %, more preferably at least 80 wt. % of organic acid salt selected from sodium acetate, potassium acetate, sodium lactate, potassium lactate and combinations thereof. Even more preferably, the first powder contains at least 50 wt. %, more preferably at least 80 wt. % of organic acid salt selected from sodium acetate, potassium acetate and combinations thereof. Most preferably, the first powder contains at least 50 wt. %, more preferably at least 80 wt. % of sodium acetate.

Preferably, the second powder contains at least 50 wt. %, more preferably at least 80 wt. % of sodium diacetate.

In a preferred embodiment of the present process, the first, the second and the third powder each have a volume weighted average diameter (D [4,3]] in the range of 40 to 600 micrometer, more preferably in the range of 50 to 550 micrometer.

The invention is further illustrated by the following non-limiting examples.

### EXAMPLES

### Example 1

A preservative powder according to the present invention was prepared by powder blending on the basis of the recipe that is shown in Table 1.

TABLE 1

| | Wt. % |
|---|---|
| Sodium acetate (anhydrous) | 72 |
| Sodium diacetate | 14 |
| Disodium diphosphate | 12 |
| Silica (Sipernat ® 22 S, ex Evonik) | 2 |

The particle size distribution of the powder mixture, as determined by laser diffraction (Malvern) is shown in Table 2.

TABLE 2

| D(v, 0.1) | D(v, 0.5) | D(v, 0.9) | D[4, 3] | |
|---|---|---|---|---|
| in μm | in μm | in μm | in μm | Span |
| 54.3 | 176.8 | 436.2 | 215.1 | 2.17 |

### Example 2

Hams were prepared on the basis of the recipe that is shown in Table 3.

TABLE 3

| | Parts by weight | | | |
|---|---|---|---|---|
| | | Product | Product | Product |
| | Control | A | 1 | 2 |
| Lean chicken fillet (mince) | 33.12 | 33.12 | 33.12 | 33.12 |
| Pork belly (mince) | 33.12 | 33.12 | 33.12 | 33.12 |
| Water + ice | 24.00 | 24.00 | 24.00 | 24.00 |
| Soy protein isolate | 2.00 | 2.00 | 2.00 | 2.00 |
| Tapioca starch | 2.50 | 2.50 | 2.50 | 2.50 |
| Modified tapioca starch ¹ | 2.50 | 2.50 | 2.50 | 2.50 |
| Colorozo salt ² | 1.20 | 1.20 | 1.20 | 1.20 |
| Sugar | 0.90 | 0.90 | 0.90 | 0.90 |
| Sodium tripolyphosphate | 0.30 | 0.30 | 0.30 | 0.30 |
| Monosodium glutatamate | 0.08 | 0.08 | 0.08 | 0.08 |
| Spice mix | 0.28 | 0.28 | 0.28 | 0.28 |
| Opti. form Powder Ace S61 ³ | | 0.60 | | |
| Preservative powder Example 1 | | | 0.40 | 0.60 |

¹ Kreation ® 20 CL, ex SMS Corp.
² 0.9% NaNO₂
³ Composition: 34% sodium acetate, 34% sodium lactate, 30% sodium diacetate, 2% silica, ex Corbion

The ingredients were processed into an emulsion using Robot Coupe R. V. 10 bowl cutter. The emulsions were stuffed into a vacuum shrink bag and cooked in a water bath set at 85° C. for 1 hour 30 minutes. The cooked emulsions were cooled down quickly in iced water and kept at 4° C. for 56 days, during which period the pH of the hams was monitored. The results are shown in Table 4.

TABLE 4

| | pH after days storage | | | | | | | | |
|---|---|---|---|---|---|---|---|---|---|
| | 0 | 7 | 14 | 21 | 28 | 35 | 42 | 49 | 56 |
| Control | 6.36 | 6.38 | 6.37 | 6.38 | 6.38 | 6.39 | 6.38 | 6.37 | 6.28 |
| Product | 6.27 | 6.27 | 6.28 | 6.29 | 6.27 | 6.27 | 6.27 | 6.29 | 6.28 |
| A | | | | | | | | | |
| Product | 6.28 | 6.29 | 6.30 | 6.29 | 6.28 | 6.28 | 6.30 | 6.30 | 6.30 |
| 1 | | | | | | | | | |
| Product | 6.22 | 6.25 | 6.25 | 6.26 | 6.28 | 6.25 | 6.26 | 6.26 | 6.25 |
| 2 | | | | | | | | | |

The hams were evaluated by an expert panel. The panellists scored the sensory attributes salty, sweetness, sourness, bitterness and meatiness on a scale of 0-10 (scores increasing with attribute intensity). Panellists also asked scored the quality of each ham on a scale of 0-10 (0=unacceptable, 10=excellent). The results of the panel evaluation as summarised in Table 5.

TABLE 5

| | Salt | Sweet | Sour | Bitter | Meaty | Quality |
|---|---|---|---|---|---|---|
| Control | 2.3 | 1.6 | 1.0 | 1.0 | 2.4 | 3.0 |
| Product A | 3.1 | 1.9 | 1.9 | 1.0 | 3.4 | 5.3 |
| Product 1 | 2.3 | 2.1 | 1.1 | 1.0 | 3.1 | 6.5 |
| Product 2 | 2.8 | 2.3 | 1.4 | 1.0 | 3.5 | 7.5 |

Microbial stability of the hams was tested as follows:

Each ham was shredded into small pieces and inoculated with shredded commercial ham at 10 wt. % dosage. The mixture was thoroughly blended in a sterile food processor, then distributed into 20 g portions in lateral filter bags and vacuum sealed for microbiological testing. Smaller quantities of the blended mixtures were vacuum packed in stomacher bags for pH measurement. Samples of vacuum sealed packages were divided into 2 sets and incubated at 4° C. and 10° C., respectively.

One pack from each set (4° C. and 10° C.) was randomly drawn out every 7 days post inoculation for microbiological measurement. Twenty grams of vacuum packed samples were combined with saline peptone water at 1:1 ratio and mixed thoroughly. The mixture was serially diluted and checked for total Viable Aerobic Count (TVAC) by spiral plating on TSA. Agar plates were incubated at 30° C. for 48 hours. Microbiological counts were expressed as log 10 of cfu/g during storage time at a specific temperature.

Using a Total Viable Aerobic Count (TVAC) of log 6 as the standard limit for spoilage, the results of the microbial tests are summarised in Table 6 (TTL is time to reach log 6.0).

TABLE 6

TTL6 (days)

| | 4° C. | 10° C. |
|---|---|---|
| Control | 20.0 | 6.3 |
| Product A | 34.8 | 8.0 |
| Product 1 | 25.0 | 9.0 |
| Product 2 | 54.0 | 14.4 |

### Example 3

A preservative powder according to the present invention is prepared by powder blending on the basis of the recipe that is shown in Table 7.

TABLE 7

| | Wt. % |
|---|---|
| Sodium acetate | 34 |
| Sodium lactate | 34 |
| Sodium diacetate | 15 |
| Disodium diphosphate | 15 |
| Fumed silica | 2 |

1. A particulate composition comprising, calculated by weight of dry matter:
(a) 25-85 wt. % of organic acid salt selected from sodium acetate, potassium acetate, sodium lactate, potassium lactate, calcium lactate, sodium propionate, potassium propionate and combinations thereof;
(b) 6-40 wt. % of diacetate component selected from sodium diacetate, potassium diacetate and combinations thereof;
(c) 5-30 wt. % of disodium diphosphate;
wherein (a), (b), and (c) together constitute at least 80 wt. % of the dry matter that is contained in the particulate composition.

2. The particulate composition according to claim 1, wherein the organic acid salt is selected from sodium acetate, potassium acetate and combinations thereof.

3. The particulate composition according to claim 2, wherein the composition comprises, calculated by weight of dry matter, 50-85 wt. % of organic acid salt selected from sodium acetate, potassium acetate and combinations thereof.

4. The particulate composition according to claim 1, wherein the composition comprises, calculated by weight of dry matter:
a) 55-80 wt. % of sodium acetate;
b) 7-30 wt. % of sodium diacetate;
c) 5-25 wt. % of disodium diphosphate.

5. The particulate composition according to claim 2, wherein the composition comprises, calculated by weight of dry matter, 20-60 wt. % of sodium acetate and 15-55 wt. % of sodium lactate.

6. The particulate composition according to claim 5, wherein the composition comprises, calculated by weight of dry matter:
a) 25-50 wt. % of sodium acetate;
b) 25-50 wt. % of sodium lactate;
c) 10-40 wt. % of sodium diacetate; and
d) 5-25 wt. % of disodium diphosphate.

7. The particulate composition according to claim 1, wherein the composition comprises 6-20 wt. % disodium diphosphate.

8. The particulate composition according to claim 1, wherein the particulate composition is a blend of at least:
(i) a first powder comprising at least 50 wt. % of organic acid salt selected from sodium acetate, potassium acetate, sodium lactate, potassium lactate, calcium lactate, sodium propionate, potassium propionate and combinations thereof;
(ii) a second powder containing at least 50 wt. % of diacetate component selected from sodium diacetate, potassium diacetate and combinations thereof;
(iii) a third powder containing at least 50 wt. % of disodium diphosphate.

9. The particulate composition according to claim 1, wherein the particulate composition has a volume weighted average diameter (D [4,3]) in the range of 100 to 500 micrometers.

10. The particulate composition according to claim 1, wherein the particulate composition has a water content of not more than 15 wt. %.

11. A method of preserving a food product, comprising:
(i) mixing one or more food ingredients with a particulate composition according to claim 1, and/or
(ii) applying the particulate composition according to claim 1 onto the surface of a food product.

12. The method according to claim 11, comprising mixing 1000 parts by weight of the one or more other ingredients with 1 to 20 parts by weight of the particulate composition.

13. The method according to claim 11, wherein the food product is a meat product.

14. A process of preparing a particulate composition according to claim 1, comprising mixing together:
(i) a first powder containing at least 50 wt. % of organic acid salt selected from sodium acetate, potassium acetate, sodium lactate, potassium lactate, calcium lactate, sodium propionate, potassium propionate and combinations thereof;
(ii) a second powder containing at least 50 wt. % of diacetate component selected from sodium diacetate, potassium diacetate and combinations thereof;
(iii) a third powder containing at least 50 wt. % of disodium diphosphate.

15. The process according to claim 14, wherein each of the first, the second and the third powder has a volume weighted average diameter in the range of 40 to 600 micrometers.
